(19) United States
(12) Patent Application Publication
(10) Pub. No.: US 2023/0388715 A1
(43) Pub. Date: Nov. 30, 2023

(54) ACOUSTIC TRANSDUCER WITH TRANSVERSALLY ORIENTED MAGNETS

(71) Applicant: PS Audio Design Oy, Oulu (FI)

(72) Inventors: Petri SORONEN, Oulu (FI); Petteri LUUKKANEN, Oulu (FI)

(21) Appl. No.: 18/249,943

(22) PCT Filed: Nov. 9, 2021
(86) PCT No.: PCT/FI2021/050756

§ 371 Date: Apr. 20, 2023

(30) Foreign Application Priority Data
Nov. 10, 2020 (FI) 20206132

(51) Int. Cl. H04R 9/02; H04R 9/04; H04R 9/06; H04R 13/00

(52) U.S. Cl. CPC H04R 9/025; H04R 9/046; H04R 9/06; H04R 13/00

(57) ABSTRACT

A transducer converts electric signals into mechanical vibrations. It has an upper part, a lower part, an outer permanent magnet arrangement and an upper cover in the upper part, and an inner permanent magnet arrangement and a lower cover in the lower part. The covers comprise magnetic material. At least one coil is configured to create, under influence of an electric current, dynamic magnetic forces in the direction of an axis line of the transducer. Said outer and inner permanent magnet arrangements are at least partly on the same level with each other. The inner permanent magnet arrangement occupies a space closer to said axis line. Oppositely named magnetic poles of the outer and inner permanent magnet arrangements face each other.

### TECHNICAL FIELD

The disclosure is generally related to the field of acoustic or haptic transducers that convert electric signals into mechanical vibrations, for example on audio frequencies. The disclosure is particularly related to acoustic or haptic transducers that can be used to make one or more surfaces of an electric device act as part(s) of the conversion.

### BACKGROUND

FIG. 1 illustrates a known acoustic transducer as such, without attachment to an electronic device, in a partially cut-out axonometric view. FIG. 2 illustrates a cross section of the same known acoustic transducer along the same plane at which the cut-out is made in FIG. 1, with a schematically shown attachment to an electronic device. An acoustic transducer of this kind is known for example from the patent application document EP3603110 A1.

The known acoustic transducer of FIGS. 1 and 2 comprises an upper part 101 and a lower part 102 separated from each other by a horizontal gap 103. The upper part is attached, at its top surface, to a first structural part 201 of an electronic device. The first structural part 201 is typically a visible or at least accessible part of the electronic device, for example its display panel. Its top surface 202 is visible or at least accessible to a user, so that the top surface 202 constitutes an interface to the surrounding air. The lower part 102 of the acoustic transducer is attached, at its bottom surface, to a second structural part 203 of the electronic device. The second structural part 203 may be for example part of a structural support frame of the electronic device. The structural relation of the first and second structural parts 201 and 203 serves to maintain the horizontal gap 103 between the upper and lower parts 101 and 102. The gap 103 may also be filled with elastic, non-magnetic material that may form an adhesion joint between the upper and lower parts 101 and 102.

A first permanent magnet 104 is located in the upper part 101, and a second permanent magnet 105 is located in the lower part 102. In the embodiment shown in FIGS. 1 and 2 the first permanent magnet 104 has the shape of a relatively flat cylinder, and the second permanent magnet 105 has the form of a relatively flat ring. The magnetic poles of the first and second permanent magnets 104 and 105 are oriented in a repelling configuration, so that their similarly named poles (either S poles or N poles) face each other. Thus the static magnetic force resulting from the mutually facing similarly named magnetic poles constantly pushes the upper and lower parts 101 and 102 away from each other.

The acoustic transducer comprises an upper cover 106 and a lower cover 107, both of which are cup-formed and made of magnetic material. The magnetic property of the upper and lower covers 106 and 107 concentrates and guides the magnetic field lines of the first and second permanent magnets 104 and 105 so that as a result, an attracting static magnetic force appears at the edges of the horizontal gap 103.

A coil 108 surrounds the second permanent magnet 105 in the lower part 102. A flat cable 109 provides an electrically conductive connection from an electronic circuit (not shown) located somewhere else in the electronic device to the coil 108. A varying electric current flowing through the coil 108 induces a dynamic magnetic field that sums up with the static magnetic fields explained above, making the upper part 101 move vertically with respect to the lower part 102. The structural stiffness of the first structural part 201 is weaker than that of the second structural part 203, so the electromagnetically induced vertical movements of the upper part 101 are converted into oscillating modes of the first structural part 201, which in turn make the first structural part 201 emit audible sounds into the surrounding air. In short, the acoustic transducer makes the first structural part 201 work like a planar loudspeaker.

FIG. 3 illustrates another known acoustic transducer. The acoustic transducer comprises an upper part 301 and a lower part 302. Similar to the embodiment of FIGS. 1 and 2, the upper part 301 of the acoustic transducer may be attached to a first structural part and the lower part 302 to a second structural part of an electronic device. A first permanent magnet 303 is located in the upper part 301 and a second permanent magnet 304 is located in the lower part 302. Similarly named magnetic poles of the first and second permanent magnets 303 and 304 face each other in the direction of the axis line 305. As a result, the basic static magnetic interaction between the first and second permanent magnets 303 and 304 is a repelling force in the direction of the axis line 305.

The acoustic transducer of FIG. 3 comprises an upper cover part 306 in the upper part 301 and a lower cover part 307 in the lower part 302. The upper and lower covers 306 and 307 comprise magnetic material, with the most important consequence that the upper and lower covers 306 and 307 confine a significant proportion of the magnetic field lines of the first and second permanent magnets 303 and 304 within their material. A ring-shaped coil 308 is located in said enclosure for creating, under influence of an electric current flowing through it, dynamic magnetic forces in the direction of the axis line 305.

In the embodiment of FIG. 3 the separating gap 309 between the edges of the upper cover 306 and the lower cover 307 is directed essentially in the direction of the axis line 305. A flat cable 310 connects the ring-shaped coil 310 to a signal source.

While the acoustic transducers of FIGS. 1 to 3 are quite effective in producing acoustic vibrations, their structural solution is such that is does not allow making the structure very thin in the vertical direction. A technical solution would be welcome that could make an acoustic transducer thinner, in order to fit in very thin portable electronic devices like smartphones for example.

### SUMMARY

It is an objective to provide an acoustic or haptic transducer and an arrangement for producing acoustic or haptic signals without the drawbacks of prior art that were described above.

According to a first aspect there is provided a transducer for converting electric signals into mechanical vibrations. The transducer comprises an upper part, a lower part an outer permanent magnet arrangement located in the upper part and an inner permanent magnet arrangement located in the lower part. An upper cover is located in the upper part and a lower cover is located in the lower part. The upper and lower covers comprise magnetic material. Together they define at least a partial enclosure around the outer and inner permanent magnet arrangements. At least one coil is located in said enclosure and configured to create, under influence of an electric current flowing through said coil, dynamic magnetic forces in the direction of an axis line. Said outer and inner permanent magnet arrangements are at least partly on the same level with each other in the direction of said axis line. Said inner permanent magnet arrangement occupies a space closer to said axis line than said outer permanent magnet arrangement. Oppositely named magnetic poles of the outer and inner permanent magnet arrangements face each other in a direction perpendicular to said axis line.

According to an embodiment said upper cover has a U-formed cross section and comprises a first pair of mutually parallel straight outer edges extending perpendicular to said U-formed cross section. The outer permanent magnet arrangement may then comprise a first pair of outer permanent magnets, each extending along a respective one of said straight outer edges inside the U-formed cross section and each having the same first magnetic pole towards the inner permanent magnet arrangement. Said inner permanent magnet arrangement may comprise a first pair of inner permanent magnets, each extending parallel to a respective one of said outer permanent magnets and each having the same second magnetic pole towards the outer permanent magnet arrangement. This involves the advantage that the desired configuration of magnets may be achieved with a relatively small number of structural parts that are relatively easy to manufacture.

According to an embodiment said upper cover has a second pair of mutually parallel straight outer edges extending in the same plane as said first pair of mutually parallel straight outer edges but in a different direction. Said outer permanent magnet arrangement may then comprise a second pair of outer permanent magnets, each extending along a respective straight outer edge of the second pair. Said inner permanent magnet arrangement may comprise a second pair of inner permanent magnets, each extending parallel to a respective outer permanent magnet of the second pair. This involves the advantage that the structure can be made to exhibit a larger degree of symmetry, which may lead to a good balance between stability and efficiency in operation.

According to an embodiment said outer permanent magnet arrangement comprises an outer rim of permanent magnets around said inner permanent magnet arrangement, each outer permanent magnet in said outer rim having the same first magnetic pole towards the inner permanent magnet arrangement. Said inner permanent magnet arrangement may then comprise an inner rim of permanent magnets inside said outer permanent magnet arrangement, each inner permanent magnet in said inner rim having the same second magnetic pole towards the outer permanent magnet arrangement. This involves the advantage that a very high degree of axial symmetry can be achieved.

According to an embodiment said coil is located in the lower part. This involves the advantage that it is relatively easy to arrange the conducting of electric currents into the coil, if the lower part is attached to a part of an electronic device where electronic circuits are located.

According to an embodiment the coil surrounds said inner permanent magnetic arrangement in a plane perpendicular to the direction of said axis line. This involves the advantage that the dynamic magnetic forces created by electric currents through the coil are very advantageously placed with respect to the other parts of the transducer structure.

According to an embodiment the lower cover is planar and extends, in said plane perpendicular to the direction of said axis line, equally far from the axis line as the combined ensemble of the coil and the inner permanent magnetic arrangement. This involves the advantage that a good balance can be achieved between structural support, directing of magnetic fields, and dimensioning of the air gap between the upper and lower parts.

According to an embodiment said upper cover comprises one or more openings around said axis line. This involves the advantage that the magnitude and effects of static magnetic forces in the transducer structure can be optimized.

According to an embodiment the lower part comprises a layer of magnetic material that separates two inner permanent magnets of said inner permanent magnet arrangement from each other in a direction perpendicular to said axis line. This involves the advantage that the magnetic field lines can be directed around the two inner permanent magnets in an optimal way.

According to a second aspect there is provided an arrangement for producing sound. The arrangement comprises an electronic device with first and second structural parts and at least one transducer of the kind described above. The upper part of the transducer is attached to said first structural part and the lower part of the transducer is attached to said second structural part of the electronic device. As part of the electronic device there is an electric circuit configured to feed electric signals at audio frequencies into said at least one coil of the transducer.

According to a third aspect there is provided an arrangement for producing haptic effects for a user to feel. The arrangement comprises an electronic device with first and second structural parts, of which at least said first part is accessible to touch by said user. The arrangement comprises also at least one transducer of the kind described above. The upper part of the transducer is attached to said first structural part and the lower part of the transducer is attached to said second structural part of the electronic device. As part of the electronic device there is an electric circuit configured to feed electric signals into said at least one coil of the transducer.

### BRIEF DESCRIPTION OF THE DRAWINGS

The accompanying drawings, which are included to provide a further understanding of the disclosure and constitute a part of this specification, illustrate advantageous embodiments and together with the description help to explain the underlying principles. In the drawings:

FIG. 1 illustrates a known transducer,

FIG. 2 illustrates a known transducer,

FIG. 3 illustrates a known transducer,

FIG. 4 illustrates a transducer according to an embodiment,

FIG. 5 illustrates the transducer of FIG. 4 in cross section,

FIG. 6 illustrates a transducer according to an embodiment in exploded view,

FIG. 7 illustrates an arrangement of magnets and coil according to an embodiment,

FIG. 8 illustrates an arrangement of magnets and coil according to another embodiment,

FIG. 9 illustrates an arrangement of magnets and coil according to another embodiment,

FIG. 10 illustrates a simulation geometry in cross section,

FIG. 11 illustrates a simulated magnetic field,

FIG. 12 illustrates another simulated magnetic field,

FIG. 13 illustrates another simulated magnetic field,

FIG. 14 illustrates another simulated magnetic field,

FIG. 15 illustrates another simulated magnetic field,

FIG. 16 illustrates another simulated magnetic field,

FIG. 17 illustrates a transducer according to an embodiment in cross section,

FIG. 18 illustrates a transducer according to an embodiment in cross section,

FIG. 19 illustrates a transducer according to an embodiment in cross section,

FIG. 20 illustrates a transducer according to an embodiment in cross section, and

FIG. 21 illustrates a transducer according to an embodiment in exploded view.

### DETAILED DESCRIPTION

This description uses the terms permanent magnet and permanent magnet arrangement. The term permanent magnet means a single piece of ferromagnetic, magnetically “hard” material that is magnetized and consequently has distinct magnetic N and S poles. The term permanent magnet arrangement means an assembly of permanent magnets, which may consist of only one permanent magnet but which in most practical embodiments explained below consists of two or more permanent magnets.

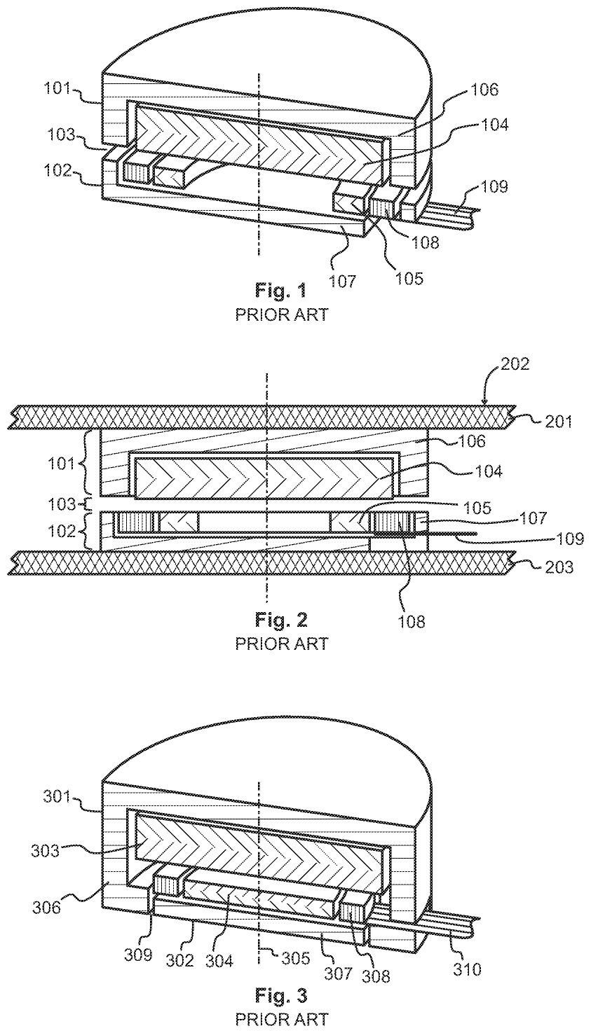

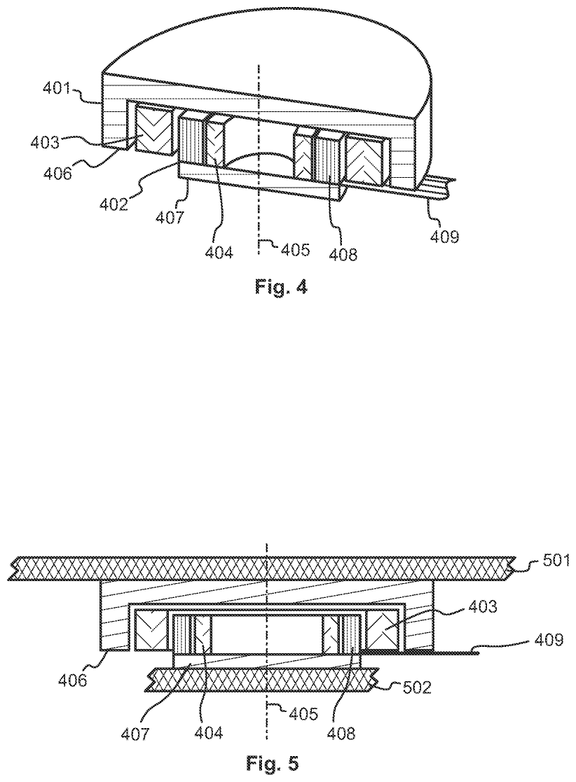

FIG. 4 illustrates a transducer for converting electric signals into mechanical vibrations, shown in axonometric cross section. The view selected in FIG. 4 is comparable to those in FIGS. 1 and 3, so that it shows the cross section along a plane that cuts the basically cylindrically symmetric form of the transducer into half. The cylindrical symmetry of the transducer is not an essential feature, but it is used here to make the comparison to FIGS. 1 to 3 more straightforward.

The transducer of FIG. 4 comprises an upper part 401 and a lower part 402. Terms that refer to a direction like “upper” or “lower” are used here only as references to the position in which the transducer is shown in the drawings, and they do not restrict the actual appearance or direction of the corresponding parts in any way in any practical embodiment. An outer permanent magnet arrangement 403 is located in the upper part 401. Similarly, an inner permanent magnet arrangement 404 is located in the lower part 402. The upper part 401, lower part 402, outer permanent magnet arrangement 403 and inner permanent magnet arrangement 404 are all cylindrically symmetric about an axis line 405 in the embodiment of FIG. 4.

An upper cover 406 is located in the upper part 401 and a lower cover 407 is located in the lower part 402. The upper cover 406 and lower cover 407 comprise magnetic material. Together they define at least a partial enclosure around the outer and inner permanent magnet arrangements 403 and 404. The enclosure being at least partial means that it does not need to be continuous: there may be gaps and openings through which at least one of the permanent magnet arrangements and/or other internal parts of the transducer may be visible. The role of the enclosure is related to confining the magnetic fields in certain spatial regions, and it will be discussed in more detail later in this text.

The transducer comprises at least one coil 408 that is located in the enclosure mentioned above. In the embodiment of FIG. 4 the coil has the general outline of a relatively flat toroid and it encircles the inner permanent magnet arrangement 404. The coil 408 is configured to create dynamic magnetic forces in the direction of the axis line 405 under influence of an electric current flowing through the coil 408.

As a difference to FIGS. 1 to 3, where the permanent magnets were in a stacked configuration in the direction of the vertical axis, in the embodiment of FIG. 4 the outer and inner permanent magnet arrangements 403 and 404 are at least partly on the same level with each other in the direction of the axis line 405. In other words, if one would draw a plane perpendicular to the axis line 405, such a plane would intersect both the outer permanent magnet arrangement 403 and the inner permanent magnet arrangement 404 if the plane is located within a certain height range along the axis line 405. The designations “outer” and “inner” come from the fact that the inner permanent magnet arrangement 404 occupies a space closer to the axis line 405 than the outer permanent magnet arrangement 403.

Oppositely named poles of the outer and inner permanent magnet arrangements 403 and 404 face each other in a direction perpendicular to said axis line 405. In other words, if the inside of the outer permanent magnet arrangement 403 is of the polarity N, the outside of the inner permanent magnet arrangement 404 is of the polarity of S, and vice versa. In the embodiment of FIG. 4 the outer permanent magnet arrangement 403 and the inner permanent magnet arrangement 404 both consist of only one ring-shaped permanent magnet respectively, so if the inner edge of the ring-shaped permanent magnet in the outer permanent magnet arrangement 403 is of one magnetic polarity, the outer edge of the ring-shaped permanent magnet in the inner permanent magnet arrangement 404 is of the other magnetic polarity.

General roles of the upper and lower parts 401 and 402 in an arrangement for producing sound and/or haptic effects are shown schematically in FIG. 5. It is assumed that an electronic device comprises a first structural part 501 and a second structural part 502. The upper part 401 of the transducer is attached to the first structural part 501 and the lower part 402 of the acoustic transducer is attached to the second structural part 502 of the electronic device. The upper and lower parts 401 and 402 do not need to be attached to each other in any way: it is sufficient that their attachments to the respective structural parts of the electronic device are aligned at sufficient accuracy, so that once the electronic device is assembled, the parts of the transducer assume their final positions with respect to each other.

A piece of a flexible circuit board 409 or other electrically conductive means may be provided for conducting electric signals generated elsewhere in the electronic device to the transducer. Here it may be noted that the structural parts 501 and 502 do not themselves need to have any role in the electronic operation of the device, but they can be e.g. just structural panels or other sufficiently rigid entities. In such a case the device being an “electronic” device must be understood so that somewhere is the circuitry that is capable of directing to the coil 408 those alternating electric currents that will interact with the magnetic fields set up by the inner and outer permanent magnet arrangements and produce the vibrations that eventually are audible (because one of the structural parts 501 or 502 converted them into longitudinal oscillations in the surrounding medium) and/or feelable (because one of the structural parts 501 or 502 was accessible for the user to feel).

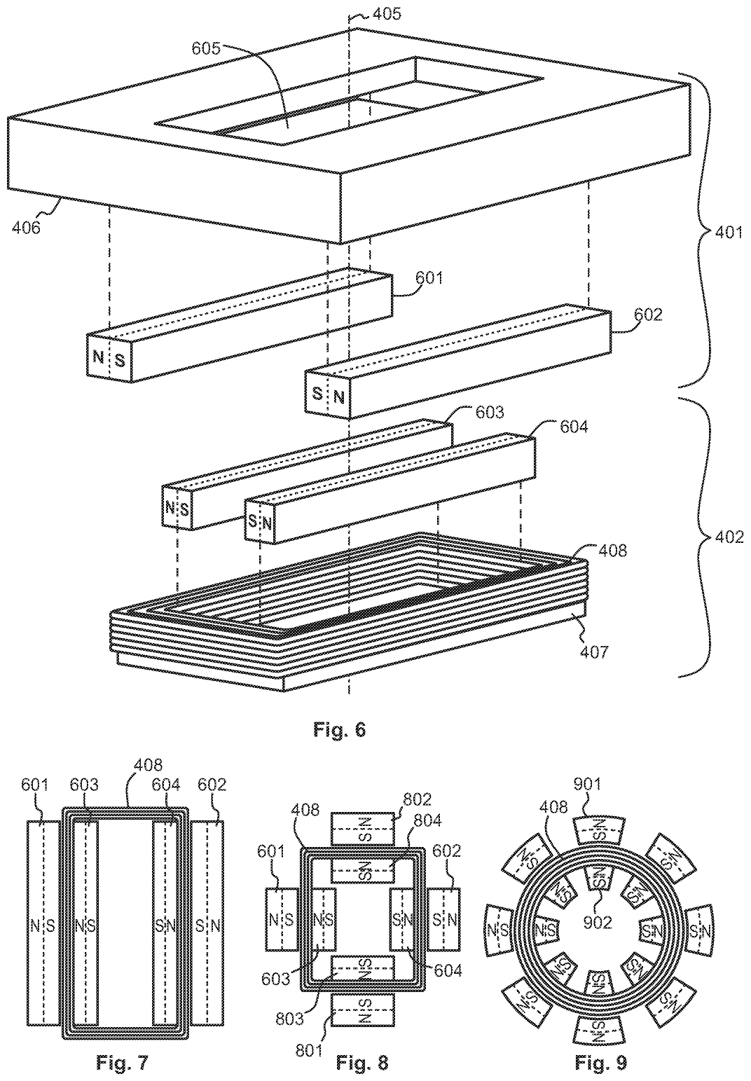

FIG. 6 illustrates a transducer according to an embodiment in an exploded view. It should be noted that the cross section shown in FIG. 5, which was first associated with FIG. 4 above, is equally applicable to the embodiment of FIG. 6 even if the one in FIG. 6 is not cylindrically symmetric.

In the embodiment of FIG. 6 (as in that of FIG. 4) the upper cover 406 has a U-formed cross section. In FIG. 6 it comprises two mutually parallel straight outer edges extending perpendicular to the U-formed cross section. One of these straight outer edges is the one extending from the middle of the page towards its right edge in FIG. 6. In the embodiment of FIG. 6 the outer permanent magnet arrangement, which was marked with the general reference designator 403 above, comprises a pair of outer permanent magnets 601 and 602. In the assembled configuration each of these extends along a respective one of the straight outer edges described above, inside the U-formed cross section. Each of the outer permanent magnets 601 and 602 has the same magnetic pole inwards, i.e. towards the inner permanent magnet arrangement in the assembled configuration. In FIG. 6 this is the S pole of each of said outer permanent magnets 601 and 602.

In the embodiment of FIG. 6 the inner permanent magnet arrangement, which was marked with the general reference designator 404 above, comprises a pair of inner permanent magnets 603 and 604. Each of these extends parallel to a respective one of the outer permanent magnets 601 or 602. The inner permanent magnets 603 and 604 both have their same magnetic pole, here the N pole towards the respective outer permanent magnet (or, in general, towards the outer permanent magnet arrangement) in the assembled configuration.

The upper cover 406 may comprise one or more openings, such as the opening 605 around the axis line 405 in FIG. 6. With openings in the upper cover 406 it is possible to affect in particular the static magnetic forces between the upper and lower parts of the transducer. An optimal number and shape of such openings may be found by experimenting and simulation.

How the pair of outer permanent magnets 601 and 602 and the pair of inner permanent magnets 603 and 604 come next to each other, separated by respective sections of the coil 408, is seen in FIG. 7. It shows a top view of a transducer of the kind shown in FIG. 6, with the upper cover 406 omitted. Also the flexible circuit board or other electrically conductive means used to connect the coil 408 to the signal source is omitted both in FIG. 6 and in FIG. 7 for graphical clarity.

FIG. 8 is a similar top view without the outer cover as FIG. 7 but shows a slightly different embodiment. Although the upper cover is not shown in FIG. 8, it may be assumed to be similar to that in FIG. 6 in the sense that it has a second pair of mutually parallel straight outer edges that extend in the same plane as the first pair described above but in a different (here: perpendicular) direction. In FIG. 6 one of these second straight edges is seen as extending from the middle towards the left edge of the page.

In FIG. 8 the outer permanent magnet arrangement of the transducer comprises a second pair of outer permanent magnets 801 and 802. These extend along those directions that would be along the respective ones of the second pair of straight outer edges of the upper cover. Also the inner permanent magnet arrangement comprises a second pair of inner permanent magnets 803 and 804, each extending parallel to a respective outer permanent magnet 801 or 802 of the second pair.

FIG. 9 shows a similar top view of a transducer according to a yet further embodiment. In FIG. 9 the outer permanent magnet arrangement comprises a total of eight outer permanent magnets, of which one is shown as an example with the reference designator 901. The inner permanent magnet arrangement comprises a corresponding number (here: eight) inner permanent magnets, one of which is shown as an example with the reference designator 902. The outer and inner permanent magnets face each other on opposite sides of the coil 408. Oppositely named magnetic poles of the outer and inner permanent magnets face each other, similar to the other embodiments described above.

In a way, the embodiment of FIG. 9 may be considered as an extrapolation of the principle shown earlier in FIGS. 7 and 8. The outer permanent magnet arrangement comprises an outer rim of permanent magnets around the inner permanent magnet arrangement. Each outer permanent magnet in said outer rim has the same first magnetic pole (here: the S pole) towards the inner permanent magnet arrangement. Correspondingly, the inner permanent magnet arrangement comprises an inner rim of permanent magnets inside the outer permanent magnet arrangement, each inner permanent magnet in said inner rim having the same second magnetic pole (here: the N pole) towards the outer permanent magnet arrangement.

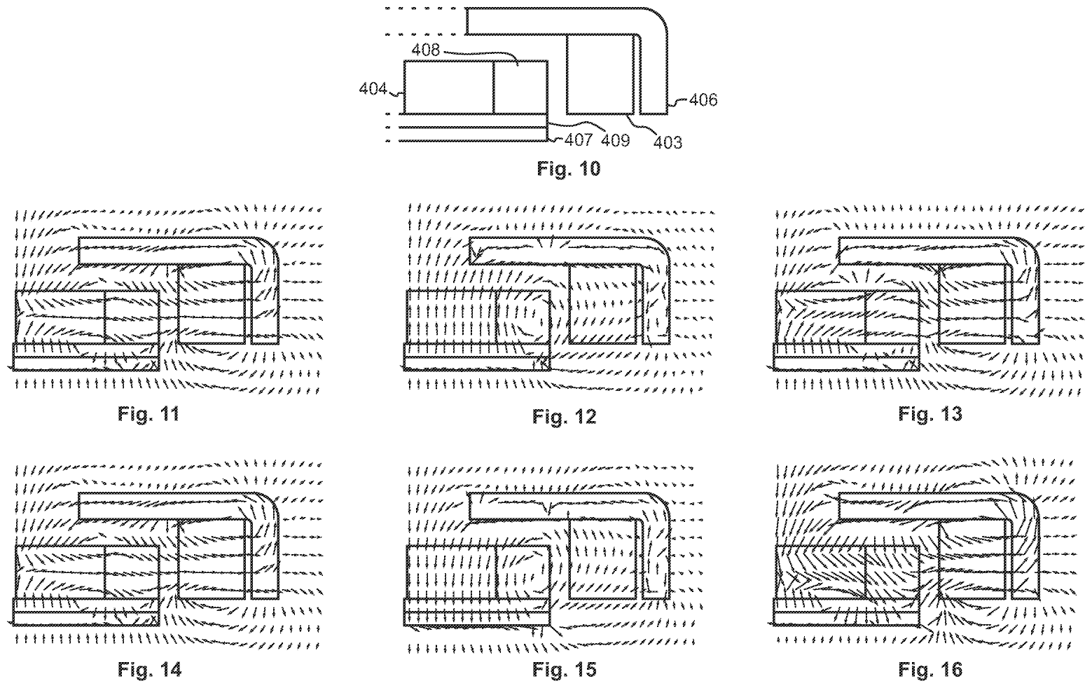

FIG. 10 illustrates a simulation geometry, where one sees the cross sections of parts of an outer permanent magnet arrangement 403, an inner permanent magnet arrangement 404, an upper cover 406, a lower cover 407, a coil 408, and a dielectric layer 409 that may be e.g. the flexible circuit board used to conduct electric signals to the coil 408. The simulation geometry is one half of a cross section such as that shown in FIG. 5. Due to symmetry it is sufficient to consider the magnetic fields in such one half.

FIGS. 11 to 16 are simulation results where the arrow matrices show the direction and approximate magnitude of the magnetic field at each calculated point. The upper line, i.e. FIGS. 11, 12, and 13, constitutes a series in which FIG. 11 shows only the magnetic fields of the permanent magnet arrangements, FIG. 12 shows only the magnetic field of the current flowing in the coil, and FIG. 13 shows the superposition of these. The lower line, i.e. FIGS. 14, 15, and 16, constitutes a similar series with the only difference that in FIG. 15 the electric current in the coil flows in the opposite direction than in FIG. 12.

The simulations show, among others, how the magnetic material of the upper and lower covers acts to confine a significant proportion of the magnetic field. This is advantageous, because any magnetic flux that escapes out of the structures of the transducer is lost in the sense that it is difficult to utilize it for any of the desired operation, i.e. the generation of the vibrations that eventually produce the audible signal and/or the haptic effect.

The superposition FIGS. 13 and 16 also show how the combined effect of the magnetic fields of the permanent magnets and that of the current flowing in the coil creates concentrated regions of magnetic field, which in turn generate the forces that are responsible for generating the vibrations. Here it may be assumed that the lower part of the transducer is fixedly attached to a relatively rigid part of the base device, such as a structural body for example. The upper part of the transducer may be fixedly attached to another part of the base device, which other part is relatively more flexible so that it can move under the influence of the forces generated in the transducer.

The embodiments described so far have the common feature that the coil 408 is located in the lower part of the transducer. This may be advantageous from at least the viewpoint of bringing the electric signals to the coil, if the lower part of the transducer is fixedly attached to such a part of the base device that also offers structural support for those electronic circuits that generate the signals. Also in the embodiments described so far the coil surrounds the inner permanent magnet arrangement in a plane perpendicular to the axis line of the transducer.

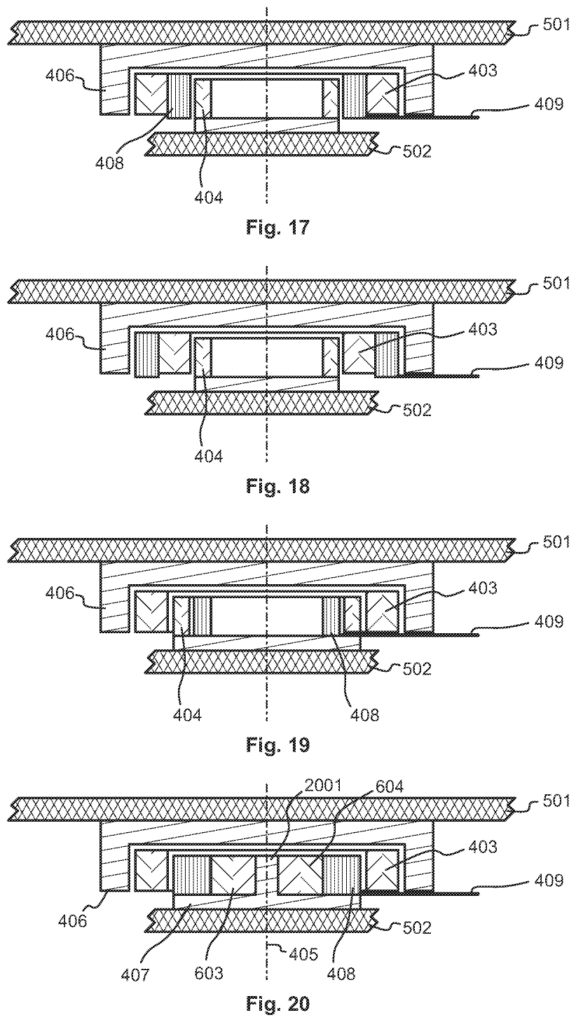

Also other ways are possible with respect to placing the coil in relation to the permanent magnet arrangements and in relation to the upper and lower parts. Some alternative embodiments are shown in FIGS. 17 to 19. In the embodiment of FIG. 17 the coil 408 is located in the upper part, fixedly attached to the inside of the outer permanent magnet arrangement 403. Otherwise the structure is similar to that in FIG. 5. In the embodiment of FIG. 18 the coil is also located in the upper part, but outside the outer permanent magnet arrangement. In the embodiment of FIG. 19 the coil is located in the lower part, inside the inner permanent magnet arrangement 404.

Any of the embodiments shown here could additionally have one or more openings in the upper cover, for example in the middle region around the axis line. As was pointed out above, such one or more openings may be used to fine tune the magnitude and effect of the static magnetic forces between the upper and lower parts of the transducer. As an example, it may be advantageous to avoid too strong static magnetic forces in the attracting direction, in order to ensure that the upper and lower parts of the transducer will not snap magnetically into each other in the case of any unexpectedly large externally caused mutual movement.

The alternative locations of the coil shown here may be also interpreted so that the transducer could comprise more than one coil, so that the two or more coils could be placed in some kind of combination of the possible coil locations that are described here.

In those embodiments where the coil 408 is located in the lower part 402 and surrounds the inner permanent magnet arrangement 404 in a plane perpendicular to the direction of the axis line 405, it may be advantageous to have the lower cover 407 planar and extending equally far from the axis line 405 as the combined ensemble of the coil 408 and the inner permanent magnet 404. Such outline and dimensioning of the lower cover 407 is seen in FIGS. 4, 5, and 20, and also in the simulation geometry of FIGS. 10 to 16. Here the extending of the lower cover 407 equally far from the axis line 405 as the combined ensemble of the coil 408 and the inner permanent magnet arrangement 404 applies in particular in those portions of the transducer where the outer permanent magnet is right adjacent thereto, facing the coil 408 and the inner permanent magnet arrangement 404. The advantages of such dimensioning are related to making the lower cover 407 take part in confining the magnetic field in optimal way, while simultaneously allowing a sufficient air gap between the upper and lower parts to enable their mutual movements in the direction of the axis line.

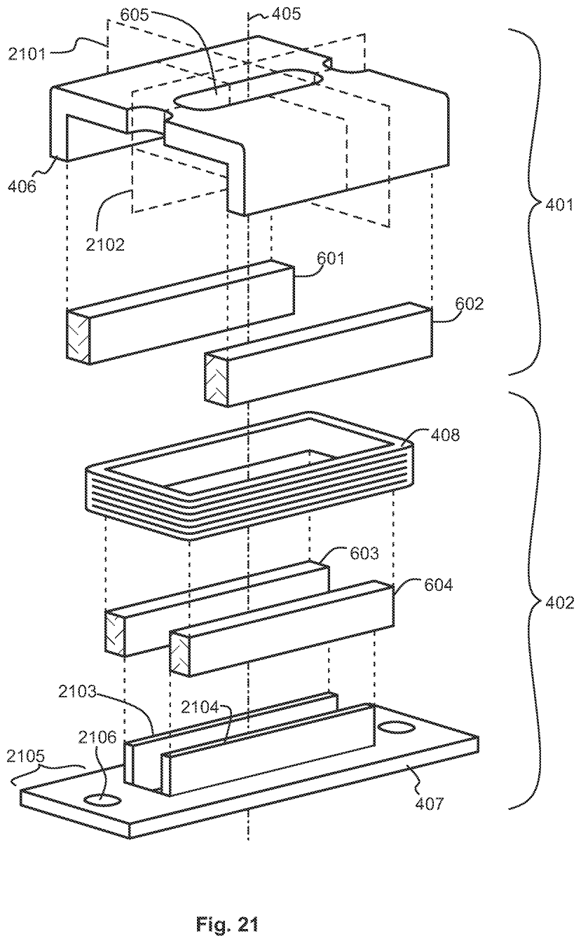

FIG. 20 shows an additional possible feature, where the lower part comprises a layer 2001 of magnetic material that separates the two inner permanent magnets 603 and 604 from each other. In FIG. 20 the two inner permanent magnets 603 and 604 are assumed to be elongate similar to those in FIG. 6 earlier. The layer 2001 then extends in their longitudinal direction, separating the two inner permanent magnets 603 and 604 for at least a significant proportion of their length. Such a separating layer of magnetic material may have an advantageous effect in directing the magnetic fields. The layer 2001 of magnetic material may be a separate piece of magnetic material that is welded or otherwise attached to the planar piece that constitutes the majority of the lower cover 407. As an alternative, it may be of the same piece of material as the planar portion, for example so that the lower cover could consist of two pieces of L-shaped cross section welded, soldered, or glued together back-to-back.

FIG. 21 illustrates a transducer according to an embodiment in exploded view. The transducer of FIG. 21 comprises an upper part 401 and a lower part 402. The upper cover 406 in the upper part has a U-formed cross section in one plane (see fictitious plane 2101) but not in the other, perpendicular plane (see fictitious plane 2102 in FIG. 21). The upper cover 406 and the lower cover 407 in the lower part 402 both comprise magnetic material. Together they define at least a partial enclosure around the outer and inner permanent magnets in the assembled configuration. If the enclosure was examined in a cross section along plane 2101, it would be more enclosing than in a respective cross section along plane 2102, because the ends of the upper cover 406 do not have the bent edges that constitute the two linear branches of the U in the cross section along plane 2101.

In some embodiments the upper cover 406 could have a form that is an intermediate version of those shown in FIGS. 6 and 21. For example, the ends of the upper cover that in FIG. 21 are without any bent edges could have small bent edges that do not reach as far downwards as those on the sides.

The transducer of FIG. 21 comprises a coil 408 that in the assembled configuration will be located in the enclosure that the upper cover 406 and lower cover define around the outer and inner permanent magnets. As was pointed out above, the enclosure will be somewhat open at its ends, so the coil 408 being located in the enclosure refers mainly to those sections of the coil 408 that extend parallel to the bent edges of the upper cover 406. The coil 408 is configured to create, under influence of an electric current flowing therethrough, dynamic magnetic forces in the direction of the axis line 405 of the transducer.

The outer permanent magnet arrangement in the upper part 401 comprises a pair of outer permanent magnets 601 and 602, each extending along a respective straight outer edge inside the U-formed cross section of the upper cover 406. The inner permanent magnet arrangement in the lower part 402 comprises a pair of inner permanent magnets 603 and 604, each extending parallel to a respective one of the outer permanent magnets 601 and 602. In the assembled configuration the pairs of outer and inner permanent magnets 601, 602, 603, and 604 are at least partly on the same level with each other in the direction of the axis line 405. As the names suggest, the inner permanent magnets 603 and 604 occupy a space closer to the axis line 405 than the outer permanent magnets 601 and 602. Oppositely named magnetic poles of the outer and inner permanent magnets face each other in the direction perpendicular to the axis line 405 (when observed in the plane 2101).

The coil 408 is located in the lower part 402 in the transducer of FIG. 21. In the assembled configuration it surrounds the pair of inner permanent magnets 603 and 604 in a plane perpendicular to the direction of the axis line 405. The lower cover 407 is generally planar, but it comprises two layers 2103 and 2104 of magnetic material that separate the inner permanent magnets 603 and 604 from each other in a direction perpendicular to the axis line 405. The two layers 2103 and 2104 have been formed by making a cut of wide H-shape in the plate-like material of the lower cover 407 and bending the two flaps so formed out of the plane of the otherwise planar outer cover 407.

It may be noted here that having an empty space in the middle of the lower part, such as the empty space between the two layers 2103 and 2104, does not serve any advantageous purpose concerning the operation of the transducer. The empty space only occurs in the embodiment of FIG. 21 because this is one relatively advantageous way to manufacture the lower cover 407. If saving space is a priority, it may be better to aim at a structure such as in FIG. 20, where the empty space between the inner permanent magnets 603 and 604 has been eliminated.

The upper cover 406 comprises one or more openings 605 around the axis line 405 for fine tuning the static magnetic forces. Also the layers 2103 and 2104 of magnetic material that separate the inner permanent magnets 603 and 604 from each other have a role in directing the magnetic fields.

A yet further specific feature of the transducer of FIG. 21 is that the base plate of the lower cover 407 extends significantly further at the ends of its elongated form than the upper cover 406. The portion extending this way at one of the ends is shown with reference designator 2105 in FIG. 21. Holes or slots in these extending portions, of which hole 2106 is shown as an example, may be useful in attaching the lower part 402 to a structural part of the electronic device in which the transducer of FIG. 21 is to produce sound and/or haptic effects. Many other kinds of attachment designs could be formed utilizing such extending portions of the lower cover 407.

In all embodiments the transversal arrangement of magnets, i.e. having the outer and inner magnets face each other in a direction perpendicular to the vertical axis line of the transducer rather than stacking them on top of each other, enables making the transducer significantly thinner in the vertical direction than prior art transducers such as those in FIGS. 1 to 3.

It is obvious to a person skilled in the art that with the advancement of technology, the basic ideas explained above may be implemented in various ways. The disclosure and embodiments are thus not limited to the examples described above, instead they may vary within the scope of the claims. As an example, parts such as the upper and lower covers that have been disclosed as being made of respective single pieces of material above can be made of two or more pieces. If larger wall thicknesses are needed, it may be more advantageous to use two or more layers of metallic material welded together than a thicker billet.

1. Transducer for converting electric signals into mechanical vibrations, the transducer comprising:
an upper part and a lower part,
an outer permanent magnet arrangement located in the upper part and an inner permanent magnet arrangement located in the lower part,
an upper cover in the upper part and a lower cover in the lower part, said upper and lower covers comprising magnetic material and together defining at least a partial enclosure around the outer and inner permanent magnet arrangements, and
at least one coil located in said enclosure and configured to create, under influence of an electric current flowing through said coil, dynamic magnetic forces in the direction of an axis line of the transducer;
wherein said outer and inner permanent magnet arrangements are at least partly on the same level with each other in the direction of said axis line, said inner permanent magnet arrangement occupying a space closer to said axis line than said outer permanent magnet arrangement,
and
wherein oppositely named magnetic poles of the outer and inner permanent magnet arrangements face each other in a direction perpendicular to said axis line.

2. Transducer according to claim 1, wherein:
said upper cover has a U-formed cross section and comprises a first pair of mutually parallel straight outer edges extending perpendicular to said U-formed cross section,
said outer permanent magnet arrangement comprises a first pair of outer permanent magnets, each extending along a respective one of said straight outer edges inside the U-formed cross section and each having the same first magnetic pole towards the inner permanent magnet arrangement, and
said inner permanent magnet arrangement comprises a first pair of inner permanent magnets, each extending parallel to a respective one of said outer permanent magnets and each having the same second magnetic pole towards the outer permanent magnet arrangement.

3. Transducer according to claim 2, wherein:
said upper cover has a second pair of mutually parallel straight outer edges extending in the same plane as said first pair of mutually parallel straight outer edges but in a different direction,
said outer permanent magnet arrangement comprises a second pair of outer permanent magnets, each extending along a respective straight outer edge of the second pair, and
said inner permanent magnet arrangement comprises a second pair of inner permanent magnets, each extending parallel to a respective outer permanent magnet of the second pair.

4. Transducer according to claim 1, wherein:
said outer permanent magnet arrangement comprises an outer rim of permanent magnets around said inner permanent magnet arrangement, each outer permanent magnet in said outer rim having the same first magnetic pole towards the inner permanent magnet arrangement, and
said inner permanent magnet arrangement comprises an inner rim of permanent magnets inside said outer permanent magnet arrangement, each inner permanent magnet in said inner rim having the same second magnetic pole towards the outer permanent magnet arrangement.

5. Transducer according to claim 1, wherein said coil is located in the lower part.

6. Transducer according to claim 5, wherein the coil surrounds said inner permanent magnetic arrangement in a plane perpendicular to the direction of said axis line.

7. Transducer according to claim 5, wherein the lower cover is planar and extends, in said plane perpendicular to the direction of said axis line, equally far from the axis line as the combined ensemble of the coil and the inner permanent magnetic arrangement.

8. Transducer according to claim 1, wherein said upper cover comprises one or more openings around said axis line.

9. Transducer according to claim 1, wherein the lower part comprises a layer of magnetic material that separates two inner permanent magnets of said inner permanent magnet arrangement from each other in a direction perpendicular to said axis line.

10. Arrangement for producing sound, comprising:
an electronic device with first and second structural parts,
at least one transducer comprising:
an upper part and a lower part,
an outer permanent magnet arrangement located in the upper part and an inner permanent magnet arrangement located in the lower part,
an upper cover in the upper part and a lower cover in the lower part, said upper and lower covers comprising magnetic material and together defining at least a partial enclosure around the outer and inner permanent magnet arrangements, and
at least one coil located in said enclosure and configured to create, under influence of an electric current flowing through said coil, dynamic magnetic forces in the direction of an axis line of the transducer;
wherein said outer and inner permanent magnet arrangements are at least partly on the same level with each other in the direction of said axis line, said inner permanent magnet arrangement occupying a space closer to said axis line than said outer permanent magnet arrangement,
and wherein oppositely named magnetic poles of the outer and inner permanent magnet arrangements face each other in a direction perpendicular to said axis line,
and wherein the upper part of the transducer is attached to said first structural part and the lower part of the transducer attached to said second structural part of the electronic device,
and wherein the electronic device comprises an electric circuit configured to feed electric signals at audio frequencies into said at least one coil of the transducer.

11. Arrangement for producing haptic effects for a user to feel, comprising:
an electronic device with first and second structural parts, of which at least said first part is accessible to touch by said user,
at least one transducer comprising:
an upper part and a lower part,
an outer permanent magnet arrangement located in the upper part and an inner permanent magnet arrangement located in the lower part,
an upper cover in the upper part and a lower cover in the lower part, said upper and lower covers comprising magnetic material and together defining at least a partial enclosure around the outer and inner permanent magnet arrangements, and
at least one coil located in said enclosure and configured to create, under influence of an electric current flowing through said coil, dynamic magnetic forces in the direction of an axis line of the transducer;
wherein said outer and inner permanent magnet arrangements are at least partly on the same level with each other in the direction of said axis line, said inner permanent magnet arrangement occupying a space closer to said axis line than said outer permanent magnet arrangement,
and wherein oppositely named magnetic poles of the outer and inner permanent magnet arrangements face each other in a direction perpendicular to said axis line,
and wherein the upper part of the transducer is attached to said first structural part and the lower part of the transducer attached to said second structural part of the electronic device,
and wherein the electronic device comprises an electric circuit configured to feed electric signals into said at least one coil of the transducer.
